(19) United States
(12) Patent Application Publication
(10) Pub. No.: US 2013/0092649 A1
(43) Pub. Date: Apr. 18, 2013

(54) Double-Layer Stainless Steel Intelligence Milk Bottle Design

(71) Applicant: Jie-Feng Yi, (US)

(72) Inventor: Jie-Feng Yi, (US)

(21) Appl. No.: 13/276,284

(22) Filed: Oct. 18, 2011

(51) Int. Cl. A61J 9/08

(52) U.S. Cl. 215/11.6

(57) ABSTRACT

A double-side stainless steel intelligence milk bottle offers the detecting of temperature, and display of temperature function. The technique is that it includes a main body, nipple, and bottle cover; said main body has a design of opening and seals it with waterproof silicone gum. This invention can detect temperature and shows it on display. In addition, this invention is environmental, safety, heat proof, good in quality, heat preservation, etc.

### FIELD OF THE INVENTION

This invention involves a life equipment of double layer stainless steel.

### DESCRIPTION OF PRIOR ARTS

There are many types of milk bottles, and all of them are made from glass or plastic material.

The advantage of milk bottle is that it is light, not fragile, and easy to carry whether by user or by baby, but it is not durable; once the liquid is high, the bottle deforms easily; the general milk bottle of heat preservation is bad; the more the more the liquid is, the hotter the main body is; thus it is easy to have heat-burnt.

The advantage of this bottle is that it is more of transparent, easy to wash, heat proof, and not easy to deform, but the intensity of the bottle is not good and is fragile; it is not heat resist, and whenever the liquid is hot, the temperature is high; it is easy to have heat-burnt.

In addition, the general milk bottle can only feed baby without knowing the temperature of liquid; thus users can test the liquid temperature by skin or mouth; this is not sanitary and have infection, which is bad for children.

### SUMMARY OF THE INVENTION

### First: The Invention Technique

This invention tries to improve the defects the general milk bottle, and makes a detected, display temperature of double-layer stainless steel intelligence bottle milk.

To improve the problem, this double-layer stainless steel intelligence bottle milk includes: a bottle, a nipple, and a cover:

which is characteristic in that:

A double-side stainless steel intelligence milk bottle, which includes: a bottle body (1), nipple (2), and bottle cover (3); which is characteristic in that:

said bottle body (1) has a design of opening (14), and a transparent water proof silicone gum (4) on opening (14) of bottle body (1); through waterproof silicone gum (4), users can seal opening (14).

A double-side stainless steel intelligence milk bottle, according the description above, is characteristic in that: said bottle body (1) is composed of outer main body (11), internal bile (12), and tooth screw (13); on the up and side down of bottle body (11), there is a design of break proof silicone (9).

A double-side stainless steel intelligence milk bottle, according to the description above, is characteristic in that: said opening (14) includes a internal bore (141) on internal bile (12), and a exterior bore (142) on outer main body (11).

A double-side stainless steel intelligence milk bottle, according to the description above, is characteristic in that: said exterior bore (142) extends to bottle body (1) and makes a snap ring (17); said internal bore (141) extends to bottle body (1) and makes a snap ring (18).

A double-side stainless steel intelligence milk bottle, according to the description above, is characteristic in that: said waterproof silicone gum (4) is in strip form and alongside, there is snap ring (18) of internal bore (141), which connects with groove (41); the side of waterproof silicone gum (4) has a design of groove position (42).

A double-side stainless steel intelligence milk bottle, according to the description above, is characteristic in that: said groove (41) is composed of front end groove (411) and posterior end groove (412); front end groove (411) has said groove position (42), and said front end groove (411) is between outer main body (11) and internal bile (12); posterior end groove (412) and internal bore (141) closely connect with each other; said snap ring (18) of internal bore (141) is in groove (41); snap ring (17) of exterior bore (142) connects with groove position (42).

A double-side stainless steel intelligence milk bottle, according to the description above, is characteristic in that: said nipple (2) includes inner cap (21) of tooth screw (13), external lid (22) of inner cap (21), and tip (23) of external lid (22).

A double-side stainless steel intelligence milk bottle, according to the description above, is characteristic in that: said internal bile (12) and outer main body (11) forms a space; said space has a intelligence temperature (5); display screen (51) of intelligence temperature controller (5) is on outer main body (11).

### Second: The Comparison of Prior Art

1. This double-side stainless steel intelligence milk bottle is sanitary, safe, better temperature perseverance, unbreakable, better clean, etc.

2. This invention has the function of temperature detect, display function, and there is temperature controller, which is n main body, so users can know the liquid temperature without taste it by mouth or skin to be more clean, and convenient; in addition, this invention can prevent the infection between children and users.

3. This invention is energy-saving; there is temperature display and a switch; whenever it is on, the temperature shows on LCD when the liquid pass through sensors. The switch is touch screen with silicone to prevent the vibration. The chip can stop after 2 minutes without movement.

4. This invention has disinfection heating device; when the cover is open, the cover and the opening can connect; the heating tube is in the internal bile of milk bottle; when this bottle is connected with electricity, it can disinfection of internal bile within 3 to 5 minutes; when the liquid is lower than 1000 ml, it will stop automatically; when there is a dry bottom, it will stop after 1 minutes of dry up.

5. The scope of screen is −10 C to 99 C, and the working temperature is about −10 C to 65 C; when the temperature is lower than 35 C, the word is in yellow color; when the temperature is higher than 40 C, the word is in red color, when the temperature is 35 C to 40 C, it is green word without alarm; Led will only shine for 5 seconds, and when it changes to other temperature, the LED and its alarm will shift to the original phrase; when Led is off, it will in black word. Said alarm has the followings: a. soft music, b. vocal reminder; c. hymning alarm; it is convenient to use.

6. The battery of this invention is CR3450, 3V, 600 Mah, and the capacity of battery can last for 1 year. This battery can be replaced.

7. This invention is heat resistance, and this invention adopts double-layer stainless steel; even though the liquid is high, the main body will not deform; the main body will not deform because of high temperature.

8. This invention is good in quality, unbreakable, resistance to pressure, and is made of unbreakable silicone gum; this can better preserve the main body of this invention.

9. This invention is good to preserve temperature, and adopts internal bile and waterproof silicone gum; the other surface is sealed without cooling.

10. This invention adopts SUS304 material, and the silicone gum is made of high quality food material; this main body can stand high liquid without toxic, smell; it is transparent, long life, cool and high temperature resistance.

11. This invention can preserve the liquid in within a certain scope; through the electricity device, the liquid temperature, the liquid can stand in a certain scope.

### DETAILED DESCRIPTION OF THE PREFERRED EMBODIMENTS

The embodiments according to the figures are as follows:

First embodiment, as FIG. 1-3 shows, a double-layer stainless steel intelligence milk bottle includes:

A double-side stainless steel intelligence milk bottle, which includes:

a bottle body (1), nipple (2), and bottle cover (3); which is characteristic in that:

said bottle body (1) has a design of opening (14), and a transparent waterproof silicone gum (4) on opening (14) of bottle body (1); through waterproof silicone gum (4), users can seal opening (14).

A double-side stainless steel intelligence milk bottle is characteristic in that:

said bottle body (1) is composed of outer main body (11), internal bile (12), and tooth screw (13); on the up and side down of outer main body (11), there is a design of break proof silicone (9).

Said nipple (2) includes: tooth screw (13) connects with inner cap (21), which is closely connect with external lid (22) and tip (23).

Said internal bile (12) and outer main body (11) has a space, which has a design of intelligence temperature controller (5). Said intelligence temperature controller (5) includes: a energy saving switch (52), display screen (51) on outside of outer main body (11), and battery base (53) on bottom of outer main body (11).

said opening (14) includes a internal bore (141) on internal bile (12), and a exterior bore (142) on outer main body (11).

Said exterior bore (142) extends to bottle body (1) to form a snap ring (17); said internal bore (141) extends to bottle body (1) to form a snap ring (18).

Said waterproof silicone gum (4) is in strip form and alongside, there is (18) of internal bore (141), which connects with groove (41); the side of waterproof silicone gum (4) has a design of groove position (42).

Said groove (41) can form with front end groove (411) and posterior end groove (412); said front end groove (411) has a groove position (42), and said front end groove (411) is between outer main body (11) and internal bile (12); posterior end groove (412) and internal bore (141) connect closely; said snap ring (18) of internal bore (141) is on groove (41) of waterproof silicone gum (4); snap ring (17) of exterior bore (142) is closely connect with groove position (42).

For the second embodiment, as FIG. 4-7 shows, this embodiment is different from the first embodiment in that: said internal bile (12) and outer main body (11) has a space; and the space has a intelligence temperature controller (5); said outer main body (11) has a power source consent (15), and power source consent (15) can connect with power source equipment (6); said bottle body (1) has a replaceable heating disinfection device (7).

For more detail, said intelligence temperature controller (5) includes: energy saving switch (52), display screen (51) of outer main body (11), and battery base (53) on the bottom of bottle body (1); intelligence temperature controller (5) has a design of buzzer (54). Said outer main body (11) has a battery lid (16) connect with battery base (53); said battery lid (16) can connect with battery base (53).

Said power source equipment (6) includes: a temperature controller (61) to control time and temperature, temperature controller (61), power source plug (62), and USB plug (63). Said temperature controller (61) includes a body (611), users can control temperature by left knob (612) and right knob (613).

Said internal bile (12) has a low pressure heating membrane (8), and low pressure heating membrane (8) can connect with power source consent (15). Said heating disinfection device (7) includes: a main body (74), cover (71), heating pipe (72), and USB plug (73). Said main body (74) has a compressor, the surface has switch, dry up bottom, and disinfection bottom.

When it is equipped, open the battery lid (16) of outer main body (11), and place the battery into battery base (53) and cover battery lid (16); when use, turn on energy saving switch (52) and control intelligence temperature controller (5); intelligence temperature controller (5) start to detect temperature and make the temperature on display screen (51) of outer main body (11). This chip will stop automatically after 2 minutes without movement. When the energy stop, it will stop intelligence temperature controller (5).

When use power source equipment (6), the bottle can connect power source plug (62) of temperature controller (61) to power source consent (15) of outer main body (11); also the other side of temperature controller (61) can connect to USB plug (63); through regulation to control the heating time and temperature of left knob (612) and right knob (613) to heat up.

In addition, said power source equipment (6) can have better temperature preservation by controlling left knob (612) and right knob (613); through this way, we can set the time and temperature of the liquid.

When use heating disinfection device (7), use cover (71) the same as inner cap (21) to place the opening; cover (71) can closely connect with tooth screw (13) to make heating disinfection device (7) and main bottom connect; heating pipe (72) of heating disinfection device (7) is situated in internal bile (12).

Place USB plug (73) of heating disinfection device (7) on USB, turn on the switch, and open heating disinfection device (7) to select disinfection key to make water boil for 3 to 5 minutes to clean internal bile; when the water on milk bottle is lower than 100 ml; choose dry up key to for 1 minute.

For the function above, the display of display screen (51) are as follows: the display of display screen (51) is 10 C to 99 C, and the working temperature is: −10 C to 65 C;

When the temperature is lower than 35 C, the word letter is in yellow;

When the temperature is higher than 40 C, the word letter is in red; when the temperature is in 35 C to 40 C, the word is soundless and colorless;

Led shine only for 5 seconds; when turn to other temperature, Led and alarm can set to the normal function;

Led shows the black word when the temperature is normal.

Said alarm is as follows:

a. Soft music, b. vocal reminder, c. hymning alarm; it is convenient to use.

According to the embodiment of figures above, the structure, character, and effect confirms to the progressiveness and novelty to apply for Patent; the description above are better example but this invention is not limited to the figures; any invention confirms to this invention with some change belongs to the scope of this invention.

### BRIEF DESCRIPTION OF THE DRAWINGS

FIG. 1: shows the main view of first embodiment;

FIG. 2: shows the sectional view of first embodiment;

FIG. 3: shows the 3-D view of first embodiment;

FIG. 4: shows the main view of second embodiment;

FIG. 5: shows the sectional view of second embodiment;

FIG. 6: shows the milk bottle and layout of electricity of second embodiment;

FIG. 7: shows heating disinfection of second embodiment.

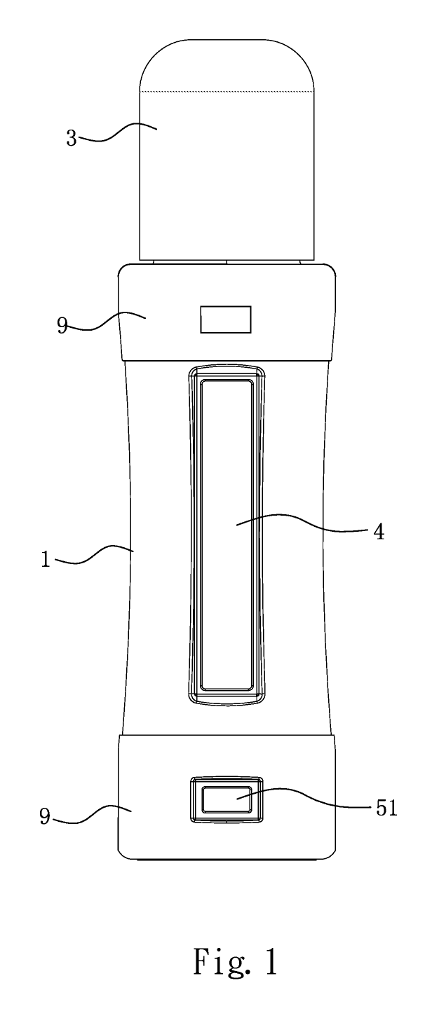

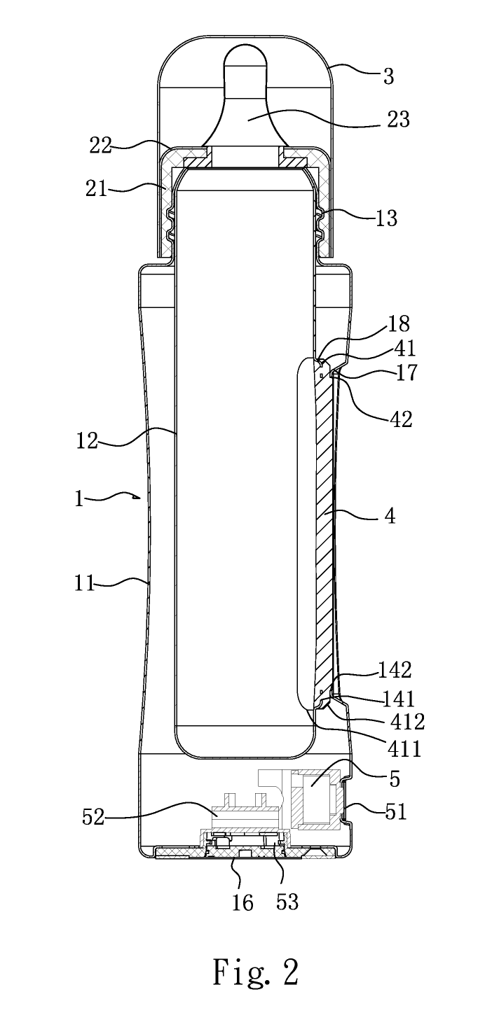

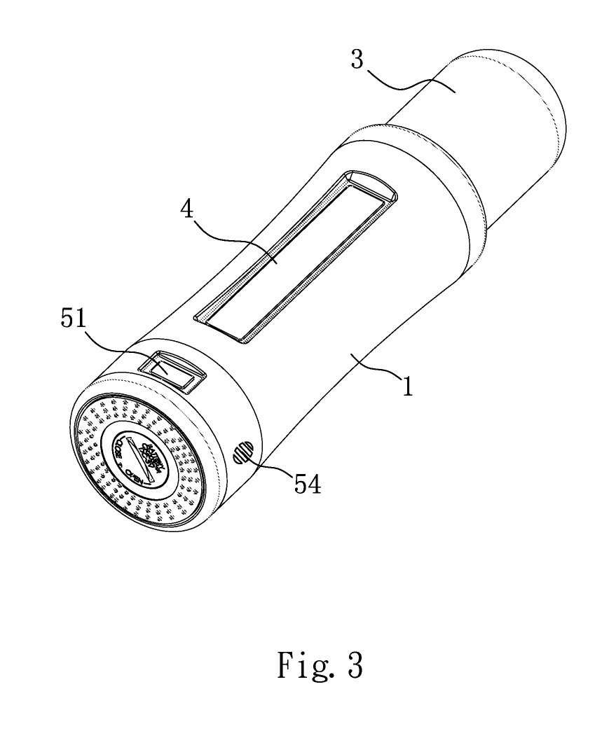

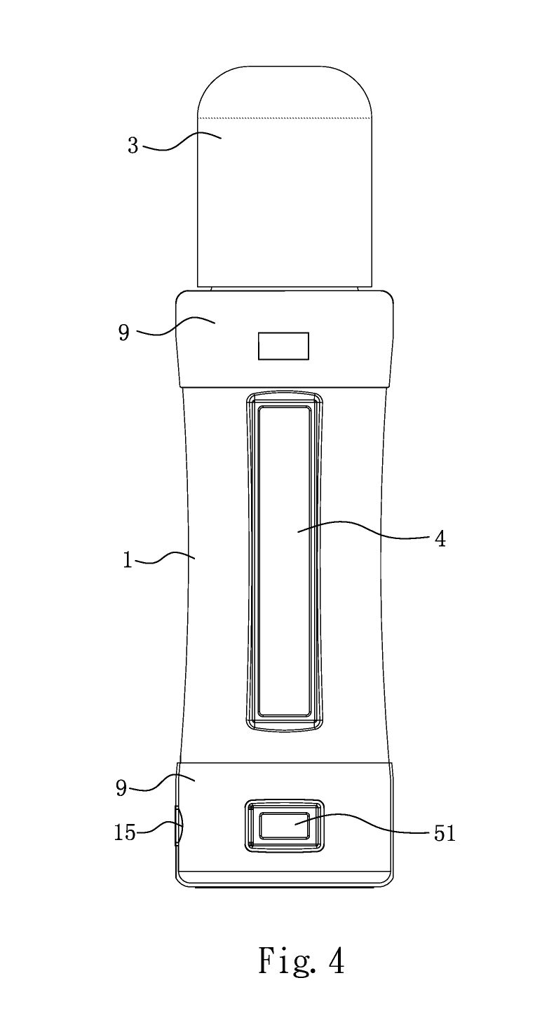

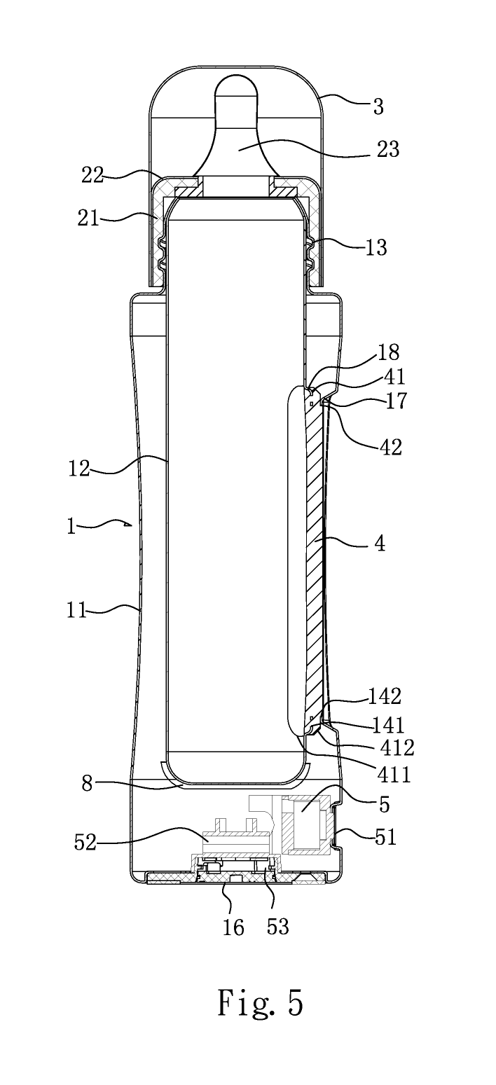

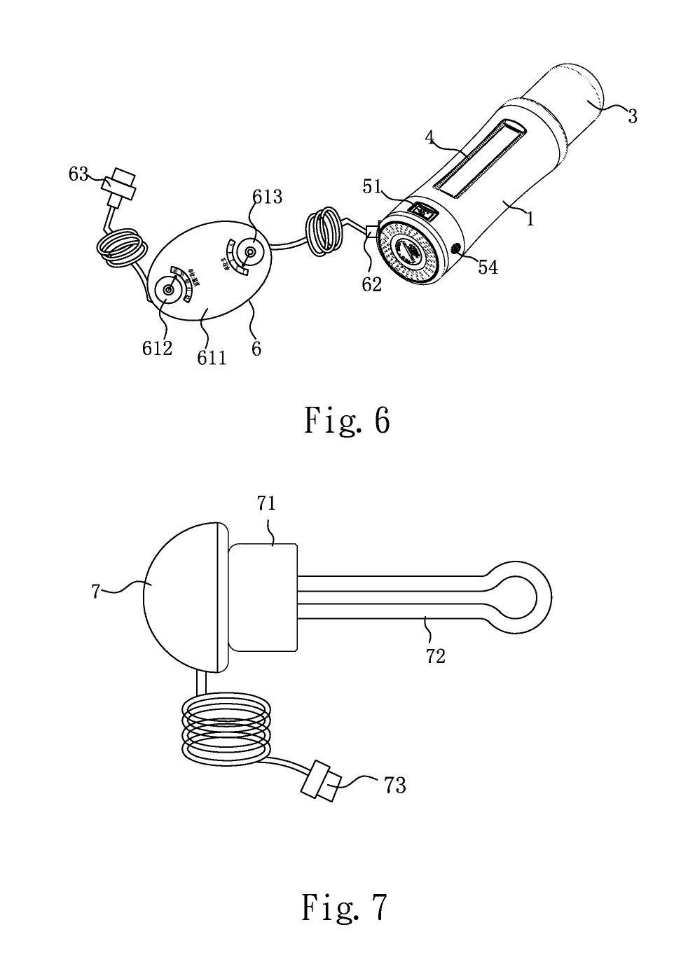

What is claim is:

1. A double-side stainless steel intelligence milk bottle, which includes:
a bottle body (1), nipple (2), and bottle cover (3); which is characteristic in that: said bottle body (1) has a design of opening (14), and a transparent waterproof silicone gum (4) on opening (14) of bottle body (1); through waterproof silicone gum (4), users can seal opening (14).

2. A double-side stainless steel intelligence milk bottle, according to claim 1, is characteristic in that: said bottle body (1) is composed of outer main body (11), internal bile (12), and tooth screw (13); on the up and side down of outer main body (11), there is a design of break proof silicone (9).

3. A double-side stainless steel intelligence milk bottle, according to claim 2, is characteristic in that: said opening (14) includes a internal bore (141) on internal bile (12), and a exterior bore (142) on outer main body (11).

4. A double-side stainless steel intelligence milk bottle, according to claim 3, is characteristic in that: said exterior bore (142) extends to bottle body (1) and makes a snap ring (17); said internal bore (141) extends to bottle body (1) and makes a snap ring (18).

5. A double-side stainless steel intelligence milk bottle, according to claim 4, is characteristic in that: said waterproof silicone gum (4) is in strip form and alongside, there is snap ring (18) of internal bore (141), which connects with groove (41); the side of waterproof silicone gum (4) has a design of groove position (42).

6. A double-side stainless steel intelligence milk bottle, according to claim 5, is characteristic in that: said groove (41) is composed of front end groove (411) and posterior end groove (412); front end groove (411) has said groove position (42), and said front end groove (411) is between outer main body (11) and internal bile (12); posterior end groove (412) and exterior bore (141) closely connect with each other; said snap ring (18) of internal bore (141) is in groove (41); snap ring (17) of exterior bore (142) connects with groove position (42).

7. A double-side stainless steel intelligence milk bottle, according to claim 1, is characteristic in that: said nipple (2) includes inner cap (21) of tooth screw (13), external lid (22) of inner cap (21), and tip (23) of external lid (22).

8. A double-side stainless steel intelligence milk bottle, according to claim 2, is characteristic in that: said internal bile (12) and outer main body (11) forms a space; said space has a intelligence temperature controller (5); display screen (51) of intelligence temperature controller (5) is on outer main body (11).
